(19) United States
(12) Patent Application Publication
(10) Pub. No.: US 2026/0127415 A1
(43) Pub. Date: May 7, 2026

(54) SYSTEMS AND METHODS FOR UTILITY-PRESERVING PRIVATE ATTRIBUTE SUPPRESSION BASED ON STOCHASTIC DATA SUBSTITUTION

(71) Applicant: JPMORGAN CHASE BANK, N.A., New York, NY (US)

(72) Inventors: Yizhuo CHEN, Champaign, IL (US); Richard CHEN, Baldwin Place, NY (US); Shaohan HU, Yorktown Heights, NY (US); Hsiang HSU, Boston, MA (US)

(21) Appl. No.: 18/939,341

(22) Filed: Nov. 6, 2024

(51) Int. Cl. G06N 3/047; G06N 3/08

(52) U.S. Cl. CPC G06N 3/047; G06N 3/08

(57) ABSTRACT

A method may include: receiving, by a computer program executed by an electronic device, an original sample to process; extracting, by the computer program, a feature from the original sample using a trained neural network, wherein the neural network may be trained to extract features from samples; calculating, by the computer program, a probability of substituting the original sample with each sample of a plurality of samples in a dataset; substituting, by the computer program, the original sample with a sample in the dataset based on the calculated probability; and returning, by the computer program, the substituted sample, wherein sensitive attributes of the original sample cannot be inferred from the substituted sample, while useful attributes of the original sample may be inferred from the substituted sample.

### BACKGROUND OF THE INVENTION

### 1. Field of the Invention

Embodiments generally relate to systems and methods for utility-preserving private attribute suppression based on stochastic data substitution.

### 2. Description of the Related Art

The growth of modern machine learning (ML) services has made data sharing increasingly common. Typically, ML service providers first collect data from users through various sensors and then analyze the data with a model to offer specific services to the user. The collected data, however, often contains sensitive or private information that users do not want to share with the service providers. For instance, a human voice recognition system may necessitate the collection of users' voice recordings, which could inadvertently expose sensitive information such as the users' gender or accent.

### SUMMARY OF THE INVENTION

Systems and methods for protecting private attributes using data-level grouping and randomization are disclosed. According to an embodiment, a method may include: receiving, by a computer program executed by an electronic device, a training dataset comprising a plurality of samples, wherein the training dataset may include sensitive attributes and useful attributes, and each sample may include a plurality of samples; drawing, by the computer program, a subset of the plurality of samples from the training dataset as substitute dataset; training, by the computer program, a learnable embedding for each sample in each sample in the substitute dataset, and a neural network to extract a feature for each sample from each sample in the training dataset, wherein the neural network and the learnable embedding using a loss function; and calculating, by the computer program, a probability distribution that may be parameterized by the trained neural network using a cosine similarity between each feature for each sample and the learnable embedding for a substitute sample for that sample.

In one embodiment, the plurality of samples may include images and/or audio.

In one embodiment, the loss function may include a first loss term associated with suppressing each sensitive attribute in the training dataset, a second loss term associated with protecting each useful attribute in the training dataset, and a third loss function associated with preserving unannotated useful attributes in the training dataset. The first loss term maximizes a conditional entropy of a substitute sample given sensitive attribute, the second loss term minimizes a cross-entropy between one of the useful attributes and a substitute useful attribute, and the third loss function minimizes a conditional entropy of a substitution probability distribution.

According to another embodiment, a method may include: receiving, by a computer program executed by an electronic device, an original sample to process; extracting, by the computer program, a feature from the original sample using a trained neural network, wherein the neural network may be trained to extract features from samples; calculating, by the computer program, a probability of substituting the original sample with each sample of a plurality of samples in a dataset; substituting, by the computer program, the original sample with a sample in the dataset based on the calculated probability; and returning, by the computer program, the substituted sample, wherein sensitive attributes of the original sample cannot be inferred from the substituted sample, while useful attributes of the original sample may be inferred from the substituted sample.

In one embodiment, the plurality of samples may include images and/or audio.

In one embodiment, unannotated useful attributes of the original sample may be inferred from the substituted sample.

In one embodiment, the step of calculating, by the computer program, a probability of substituting the original sample with each sample in the dataset uses a substitution probability distribution.

In one embodiment, the neural network may be trained with a loss function. The loss function may include a first loss term associated with suppressing each sensitive attribute in the dataset, a second loss term associated with protecting each useful attribute in the dataset, and a third loss function associated with preserving unannotated useful attributes in the dataset. The first loss term maximizes a conditional entropy of a substitute sample given sensitive attribute, the second loss term minimizes a cross-entropy between one of the useful attributes and a substitute useful attribute, and the third loss function minimizes a conditional entropy of a substitution probability distribution.

In one embodiment, the dataset may be a subset of a training dataset on which the neural network may be trained.

According to another embodiment, a non-transitory computer readable storage medium may include instructions stored thereon, which when read and executed by one or more computer processors, cause the one or more computer processors to perform steps comprising: receiving a training dataset comprising a plurality of samples, wherein the training dataset may include sensitive attributes and useful attributes, and each sample may include a plurality of samples; drawing a subset of the plurality of samples from the training dataset as substitute dataset; training a learnable embedding for each sample in each sample in the substitute dataset, and a neural network to extract a feature for each sample from each sample in the training dataset, wherein the neural network and the learnable embedding using a loss function; calculating a probability distribution that may be parameterized by the trained neural network using a cosine similarity between each feature for each sample and the learnable embedding for a substitute sample for that sample; receiving an original sample to process; extracting a feature from the original sample using the trained neural network; calculating a probability of substituting the original sample with each sample in the substitute dataset; substituting the original sample with a sample in the substitute dataset based on the calculated probability; and returning wherein the sensitive attributes of the original sample cannot be inferred from the substituted sample, while the useful attributes of the original sample may be inferred from the substituted sample.

In one embodiment, the plurality of samples may include images and/or audio.

In one embodiment, the calculating uses a substitution probability distribution.

In one embodiment, unannotated useful attributes of the original sample may be inferred from the substituted sample.

In one embodiment, the loss function may include a first loss term associated with suppressing each sensitive attribute in the training dataset, a second loss term associated with protecting each useful attribute in the training dataset, and a third loss function associated with preserving unannotated useful attributes in the training dataset, wherein the first loss term maximizes a conditional entropy of a substitute sample given sensitive attribute, the second loss term minimizes a cross-entropy between one of the useful attributes and a substitute useful attribute, and the third loss function minimizes a conditional entropy of a substitution probability distribution.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for utility-preserving private attribute suppression based on stochastic data substitution according to an embodiment.

FIG. 2 depicts a method for utility-preserving private attribute suppression based on stochastic data substitution according to an embodiment.

FIG. 3 depicts an exemplary computing system for implementing aspects of the present disclosure.

### DETAILED DESCRIPTION OF PREFERRED EMBODIMENTS

Embodiments are directed to systems and methods for utility-preserving private attribute suppression based on stochastic data substitution.

In an embodiment, a data obfuscation module may be provided for a data sharing pipeline. The data obfuscation module may remove certain sensitive data from an input sample, and may preserve useful attributes and unannotated useful attributes for downstream tasks. For example, a user may wish to remove human-identifying information from an audio clip, while protecting the spoken content and other features of the audio.

As used herein, capital letters (e.g., X, S) are used to denote random variables, and their corresponding lower-case letters (e.g., x, s) are used to denote the realization of random variables. Calligraphic letters (e.g., [symbol] ) are used to denote the datasets. P(⋅) is used to denote probability distributions (e.g., P(X)), among which P_{data}(⋅) is used to indicate that this distribution is purely determined by a dataset and can be readily calculated. P_{θ}(⋅) is used to indicate that this distribution is parameterized by neural network θ and can be calculated by forward propagation.

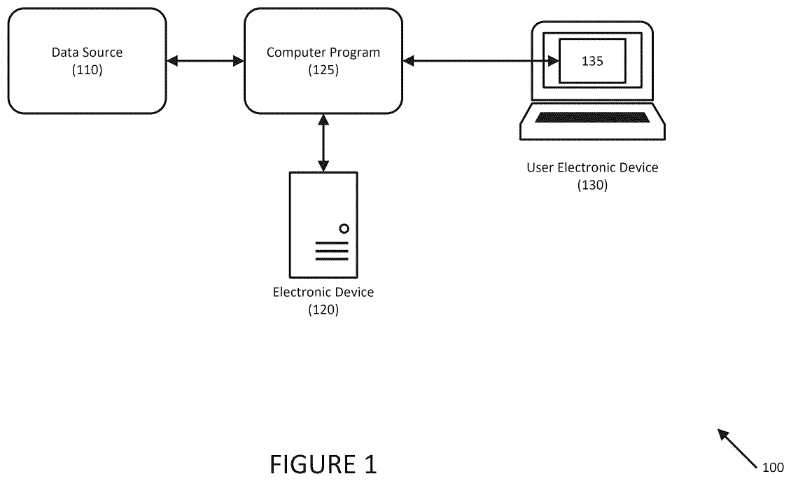

Referring to FIG. 1, a system for utility-preserving private attribute suppression based on stochastic data substitution is disclosed according to an embodiment. System 100 may include data source 110, which may be a system that may provide data to be processed, electronic device 120, such as a server (e.g., physical and/or cloud-based), a computer (e.g., workstation, desktop, laptop, notebook, tablet, etc.), etc., executing computer program 125. Computer program 125 may be data-level grouping and randomization to protect private attributes.

System 100 may further include user electronic device 130, which may execute user computer program 135. User electronic device 130 may be a server, a computer, a smart device (e.g., a smart phone, a smart watch, etc.), an Internet of Things appliance, etc. It may further include downstream systems.

User computer program 135 may receive the processed data from computer program 135, and may store, analyze, or further share the data to extract useful information and help with decision making.

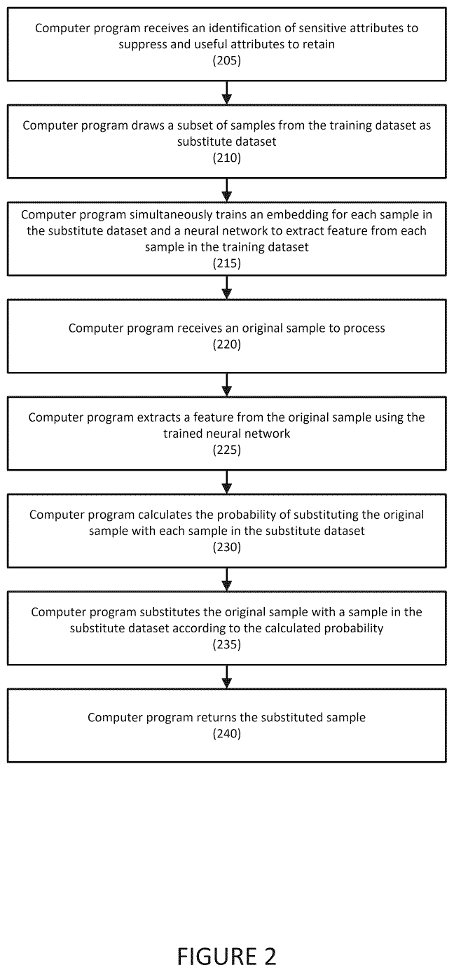

Referring to FIG. 2, a method for utility-preserving private attribute suppression based on stochastic data substitution is disclosed according to an embodiment.

In step 205, a computer program executed by an electronic device may receive, from a user, a dataset, [symbol] , that may be split into a training split [symbol] ₜᵣₐᵢₙ dataset and a test split [symbol] ₜₑₛₜ dataset. The dataset may include, for example, a plurality of samples comprising images, audio, video, combinations thereof, etc.

The splits may be drawn from the underlying data distribution [symbol] _{data}(X, S, U), where X is the high-dimensional original input samples, S={S₁, S₂, . . . , S_{M}} denotes a set of M user-chosen sensitive attributes associated with X, and U={U₁, U₂, . . . , U_{N}} denotes a set of N user-chosen useful attributes associated with X.

In one embodiment, the dataset may include a plurality of attributes, including sensitive attributes and useful attributes. In general, attributes are interpretable information. For images, examples of attributes may include sex, hair color, facial expression, etc. For audio data, examples of attributes may include sex, age, accent, etc.

Sensitive attributes may be attributes that the user may desire to obscure, and useful attributes may be attributes that the user desires to retain.

For example, using the audio example above, X may be used to denote the audio clips, and the user may choose S={“gender”, “age”, “accent”, “ID”} as sensitive attributes to remove the human-identifying information, and may choose U={“spoken digit”} as a useful attribute to preserve the spoken content. The user may select which attributes are sensitive and which attributes are useful based on their specific needs.

In step 210, the computer program may randomly draw a subset of samples from the training dataset as a substitute dataset. For example, a subset [symbol] _{substitute} may be drawn from the training dataset [symbol] ₜᵣₐᵢₙ. When there is an input original sample x, the original sample x may be substituted with a sample x′ in the substitution dataset [symbol] _{substitute} according to a stochastic substitution strategy (e.g., substitution based on probabilistic modeling).

In step 215, the computer program may train a learnable embedding for each sample in the substitute dataset, and may also train a neural network, to extract features from each sample in the training split dataset. In one embodiment, the training may be simultaneous. For example, the neural network may calculate a feature f(x) for each original input sample x (during training, input samples x are from the training split dataset; during deployment, input samples x are from the test split dataset).

In general, features are abstract, wholistic description that is only understandable to computer, such as a vector (e.g., [0.132, 0,534, 0.665, . . . ]).

A learnable embedding g(x′) may be determined for each sample in the substitute dataset, x′∈ [symbol] _{substitute}, which may significantly improve the training efficiency compared to using a neural network feature extractor for calculating g(x′).

The embedding for each substitute sample may be learnable as it may change as a result of training (e.g., using the loss function, simultaneously with the neural network), discussed below.

The substitution probability P_{θ}(X′|X), may be calculated using a cosine similarity between feature f(x) and learnable embedding g(x′) as:

$${P}_{θ} ( {X}^{′} = {x}^{′} \vert X = x ) = \frac{{e}^{cos ( f ( x ) , g ( {x}^{′} ) ) / τ}}{{\sum }_{{x}^{″} ∈ {substitute}_{}} {e}^{cos ( f ( x ) , g ( {x}^{″} ) ) / τ}}$$

where cos(⋅, ⋅) is the cosine similarity, and τ is a temperature hyperparameter. The temperature hyperparameter may be tuned by the user to adjust the concentration of the categorial distribution to achieve best model performance.

A loss function, \hat{L}, may be used to train both the neural network θ and the learnable embedding using a gradient descent algorithm. The loss function may be a weighted sum of loss terms:

$${min}_{{P}_{θ} ( {X}^{′} \vert X )} \hat{L} = {\sum }_{i = 1}^{M} {\hat{L}}_{{S}_{i}} + λ {\sum }_{i = 1}^{N} {\hat{L}}_{{U}_{j}} + μ {\hat{L}}_{X}$$

where \hat{L}_{S}_{ᵢ}, \hat{L}_{U}_{ⱼ}, and \hat{L}_{X} are loss terms responsible for suppressing each sensitive attribute Sᵢ, protecting each useful attribute Uⱼ, and preserving unannotated useful attributes, respectively. λ and μ are coefficients for \hat{L}_{U}_{ⱼ}, and \hat{L}_{X} respectively. These hyperparameters may be chosen by the user to trade-off (i.e., achieve a good balance between) privacy protection and utility preservation.

To remove the information of each sensitive attribute Sᵢ from X′, the conditional entropy of a substitute sample given sensitive attribute may be maximized. This may be achieved by minimizing the loss term \hat{L}_{S}_{ᵢ}:

$${\hat{L}}_{{S}_{i}} = - {{P}_{data} ( {S}_{i} )}_{} [ H ( P ( {X}^{′} \vert {S}_{i} ) ) ]$$

where [symbol] denotes the expectation, and H(⋅) denotes the Shannon entropy. The Shannon entropy of a random variable quantifies the average level of uncertainty or information associated with the variable's potential states or possible outcomes. The probability distribution P(X′|Sᵢ) may be calculated as:

$$P ( {X}^{′} \vert {S}_{i} ) = {{P}_{data} ( X \vert {S}_{i} )}_{} [ {P}_{θ} ( {X}^{′} \vert X ) ]$$

where the expectation over the probability distribution P_{data}(X|Sᵢ) may be estimated by averaging over all x with each class of sensitive attribute Sᵢ within each mini-batch (i.e., subsets of samples from [symbol] ₜᵣₐᵢₙ that are used to update weights).

Using the audio example, supposing Sᵢ is “gender”, the loss term \hat{L}_{S}_{ᵢ} tries to encourage that each x′ can substitute both “male” speaker's audio and “female” speaker's audio, so that the attacker cannot infer the speaker's gender of the x when observing a x′.

To preserve the useful attributes Uⱼ, the substitute useful attributes U′ⱼ are selected to be similar to original useful attributes Uⱼ. For the audio example, if “spoken digit” is the useful attribute, audio including the spoken digit “1” should also have the spoken “1”. To achieve this, the loss term \hat{L}_{U}_{ⱼ} may be minimized:

$${\hat{L}}_{{U}_{j}} = {{P}_{data} ( X )}_{} [ H ( {P}_{data} ( U {\vert}_{j} \vert X ) , P ( {U}_{j}^{′} \vert X ) ) ]$$

where H(⋅, ⋅) is cross-entropy. P(U′ⱼ|X) may be calculated as:

$$P ( {U}_{j}^{′} \vert X ) = {{P}_{θ} ( {X}^{′} \vert X )}_{} [ {P}_{data} ( {U}_{j}^{′} \vert {X}^{′} ) ] .$$

To preserve unannotated useful attributes, the Shannon mutual information, I(X′;X), may be maximized by minimizing the conditional entropy of the substitution probability distribution P_{θ}(X′|X), which may be achieved by minimizing the loss term Lx:

$${\hat{L}}_{X} = {{P}_{data} ( X )}_{} [ H ( {P}_{θ} ( {X}^{′} \vert X ) ) ]$$

\hat{L}_{X} may cause each original sample x to be substituted by a narrow range of x′∈ [symbol] _{substitute}, which has a counteracting effect on the loss term \hat{L}_{S}_{ᵢ}. When \hat{L}_{X} and \hat{L}_{S}_{ᵢ} are both used to train the substitution probability distribution P_{θ}(X′|X), their combined effect is to cause, although each x can only cover a relatively narrow range of x′, all the x with each class of Sᵢ may jointly cover a wide range of x′. Consequently, each x′ may only substitute a narrow range of x, but these x are with different classes of Sᵢ, which still hinders the attacker from inferring Sᵢ from x′, while ensuring that the downstream user can infer x from x′ with medium level of accuracy.

Using the audio example with the sensitive attribute “gender” as an example, both \hat{L}_{X} and \hat{L}_{S}_{ᵢ} cause each x′ to only substitute a limited number of x, but these x contain both “male” speaker audio and “female” speaker audio.

In step 220, after deployment, the computer program may receive an original sample, x, to process. For example, the original sample may be a sample that is to be processed to obscure the sensitive attributes while retaining the useful attributes.

In step 225, the computer program may extract a feature, f(x), from the original sample using the trained neural network. For example, the computer program may provide the original sample to the trained neural network, and the trained neural network may output a feature for the original sample.

In step 230, the computer program may calculate a probability of substituting the original sample with each sample in the substitute dataset. In one embodiment, the probability of substituting the original sample x with the substitute sample x′ is given by the substitution probability distribution P_{θ}(X′=x′|X=x) as follows:

$${P}_{θ} ( {X}^{′} = {x}^{′} \vert X = x ) = \frac{{e}^{cos ( f ( x ) , g ( {x}^{′} ) ) / τ}}{{\sum }_{{x}^{″} ∈ {substitute}_{}} {e}^{cos ( f ( x ) , g ( {x}^{″} ) ) / τ}}$$

Thus, P_{θ}(X′|X) is parameterized by a neural network θ and is trained by \hat{L}.

In step 235, the computer program may substitute the original sample with a sample in the substitute dataset according to the calculated probability. The substitution strategy may be determined such that the attacker cannot correctly infer the sensitive attributes of the original sample x from the substituted sample x′, but can still infer the useful attributes and some unannotated useful attributes, of x from x′.

In step 240, the computer program may return the substituted sample.

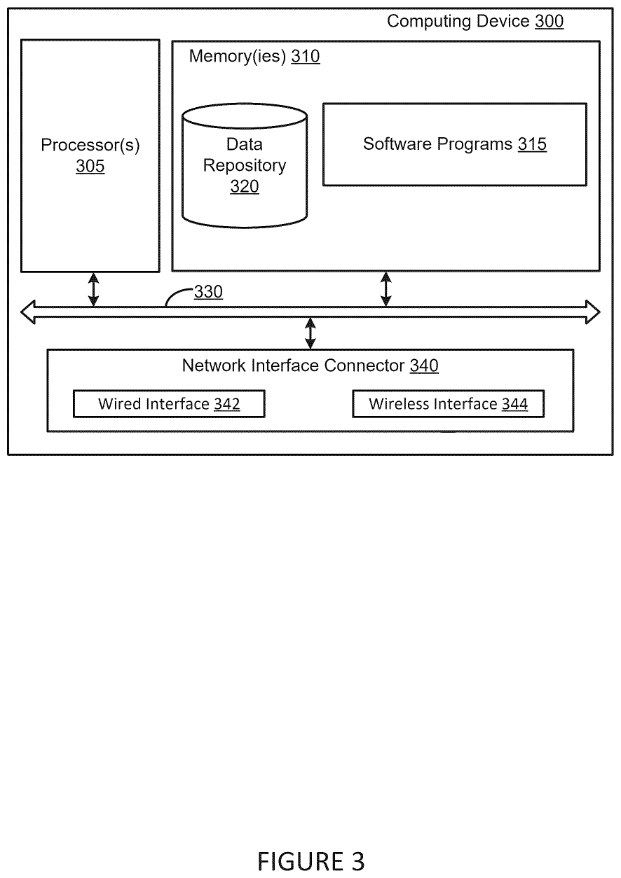

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device, a training dataset comprising a plurality of samples, wherein the training dataset comprises sensitive attributes and useful attributes, and each sample comprises a plurality of samples;
drawing, by the computer program, a subset of the plurality of samples from the training dataset as substitute dataset;
simultaneously training, by the computer program, a learnable embedding for each sample in each sample in the substitute dataset and a neural network to extract a feature for each sample from each sample in the training dataset, wherein the neural network and the learnable embedding are trained using a loss function; and
calculating, by the computer program, a probability distribution that is parameterized by the trained neural network using a cosine similarity between each feature for each sample and the learnable embedding for a substitute sample for that sample.

2. The method of claim 1, wherein the plurality of samples comprises images.

3. The method of claim 1, wherein the plurality of samples comprises audio.

4. The method of claim 1, wherein the loss function comprises a first loss term associated with suppressing each sensitive attribute in the training dataset, a second loss term associated with protecting each useful attribute in the training dataset, and a third loss function associated with preserving unannotated useful attributes in the training dataset.

5. The method of claim 4, wherein the first loss term maximizes a conditional entropy of a substitute sample given sensitive attribute, the second loss term minimizes a cross-entropy between one of the useful attributes and a substitute useful attribute, and the third loss function minimizes a conditional entropy of a substitution probability distribution.

6. A method, comprising:
receiving, by a computer program executed by an electronic device, an original sample to process;
extracting, by the computer program, a feature from the original sample using a trained neural network, wherein the neural network is trained to extract features from samples;
calculating, by the computer program, a probability of substituting the original sample with each sample of a plurality of samples in a dataset;
substituting, by the computer program, the original sample with a sample in the dataset based on the calculated probability; and
returning, by the computer program, the substituted sample, wherein sensitive attributes of the original sample cannot be inferred from the substituted sample, while useful attributes of the original sample are inferred from the substituted sample.

7. The method of claim 6, wherein the plurality of samples comprises images.

8. The method of claim 6, wherein the plurality of samples comprises audio.

9. The method of claim 6, wherein unannotated useful attributes of the original sample are inferred from the substituted sample.

10. The method of claim 6, wherein the step of calculating, by the computer program, a probability of substituting the original sample with each sample in the dataset uses a substitution probability distribution.

11. The method of claim 6, wherein the neural network is trained with a loss function.

12. The method of claim 11, wherein the loss function comprises a first loss term associated with suppressing each sensitive attribute in the dataset, a second loss term associated with protecting each useful attribute in the dataset, and a third loss function associated with preserving unannotated useful attributes in the dataset.

13. The method of claim 12, wherein the first loss term maximizes a conditional entropy of a substitute sample given sensitive attribute, the second loss term minimizes a cross-entropy between one of the useful attributes and a substitute useful attribute, and the third loss function minimizes a conditional entropy of a substitution probability distribution.

14. The method of claim 7, wherein the dataset is a subset of a training dataset on which the neural network is trained.

15. A non-transitory computer readable storage medium, including instructions stored thereon, which when read and executed by one or more computer processors, cause the one or more computer processors to perform steps comprising:
receiving a training dataset comprising a plurality of samples, wherein the training dataset comprises sensitive attributes and useful attributes, and each sample comprises a plurality of samples;
drawing a subset of the plurality of samples from the training dataset as substitute dataset;
training a learnable embedding for each sample in each sample in the substitute dataset, and a neural network to extract a feature for each sample from each sample in the training dataset, wherein the neural network and the learnable embedding are trained using a loss function;
calculating a probability distribution that is parameterized by the trained neural network using a cosine similarity between each feature for each sample and the learnable embedding for a substitute sample for that sample;
receiving an original sample to process;
extracting a feature from the original sample using the trained neural network;
calculating a probability of substituting the original sample with each sample in the substitute dataset;
substituting the original sample with a sample in the substitute dataset based on the calculated probability; and
returning wherein the sensitive attributes of the original sample cannot be inferred from the substituted sample, while the useful attributes of the original sample are inferred from the substituted sample.

16. The non-transitory computer readable storage medium of claim 15, wherein the plurality of samples comprises images.

17. The non-transitory computer readable storage medium of claim 15, wherein the plurality of samples comprise audio.

18. The non-transitory computer readable storage medium of claim 15, wherein the calculating uses a substitution probability distribution.

19. The non-transitory computer readable storage medium of claim 15, wherein unannotated useful attributes of the original sample are inferred from the substituted sample.

20. The non-transitory computer readable storage medium of claim 15, wherein the loss function comprises a first loss term associated with suppressing each sensitive attribute in the training dataset, a second loss term associated with protecting each useful attribute in the training dataset, and a third loss function associated with preserving unannotated useful attributes in the training dataset, wherein the first loss term maximizes a conditional entropy of a substitute sample given sensitive attribute, the second loss term minimizes a cross-entropy between one of the useful attributes and a substitute useful attribute, and the third loss function minimizes a conditional entropy of a substitution probability distribution.
